(19) United States
(12) Patent Application Publication
(10) Pub. No.: US 2007/0128950 A1
(43) Pub. Date: Jun. 7, 2007

(54) Multipole line interface, particularly for a motor vehicle

(75) Inventor: Peter Merget, Erlenweg (DE)

Correspondence Address: FITCH, EVEN, TABIN & FLANNERY, P. O. BOX 18415, WASHINGTON, DC, 20036, US

(73) Assignee: Daimler Chrysler AG, Stuttgart (DE)

(21) Appl. No.: 10/575,895

(22) PCT Filed: Sep. 18, 2004
(86) PCT No.: PCT/EP04/10499

§ 371 Date: Aug. 10, 2006

(30) Foreign Application Priority Data
Oct. 25, 2003 (DE) 103 49 872.9

(51) Int. Cl. H01R 13/64

(52) U.S. Cl. 439/677

(57) ABSTRACT

1. Multipole line interface, particularly for a motor vehicle.

2.1. The invention relates to a multipole line interface having a housing (1) and at least two lines which can be connected to the housing (1) by inserting a respective line contact into a respective pole chamber (2).

2.2. According to the invention, the housing (1) comprises a coding device (3) for at least one of the pole chambers (2), with the coding device (3) being designed specifically to hold an associated coding element which is connected to the associated line contact in a captive fashion. 2.3. Use, for example, for line interfaces of electrical components in a motor vehicle.

The invention relates to a multipole line interface, particularly for a motor vehicle, as claimed in the preamble of patent claim 1. The term “multipole line interface” is to be understood here as any electrical connector, for example plug connector, in which a plurality of lines are installed in a housing individually or in two or more groups by means of line contacts at their ends. In this case, the lines may be either a respective core of a multi-core line or two or more individual lines.

In vehicle production, when installing components such as a cable harness or controllers, multipole plug/coupling housings, for example at interfaces of controllers, are often only partially fitted with lines or not fitted with lines at all. When a housing of the interface is fitted with the corresponding lines, the problem then arises of it not being clear which line belongs in which pole chamber of the multipole housing. As a result, faulty contact-connection may occur when the housing is retrofitted with the individual line contacts.

The object of the invention is therefore to specify a multipole line interface, particularly for a motor vehicle, in which faulty contact-connection is prevented.

The invention achieves this object by means of a multipole line interface having the features of patent claim 1.

Advantageous developments of the invention are specified in the dependent claims.

The invention is based on the idea of assigning to the housing, for example a plug housing, of at least one of the pole chambers a coding device which is specifically designed such that it holds an associated coding element which is connected in a captive fashion to the line contact which can be inserted into the relevant pole chamber of the housing. In this case, the individual lines are fixed to the corresponding pole chamber separately.

The housing may advantageously be formed with a basic housing and an additional housing, with the pole chambers being formed on the basic housing and the one or more coding devices being formed on the additional housing. The additional housing and the basic housing may be formed integrally or from two or more parts. In an embodiment with two or more parts, the additional housing may be connected to the basic housing, particularly by means of clips.

The coding device and the coding element may satisfy their coding function, for example, by being dimensioned and/or arranged such that only the line contact which belongs to a particular pole chamber can be inserted into this pole chamber.

Separating the housing into a basic part and a coded additional part means it is possible to use a large number of basic housings and despite this to minimize the risk of confusion when fitting the housing with said lines on account of the additional part being coded. The interfaces only need to be provided with the line coding, that is to say equipped with the additional part, as required, and the basic housing can furthermore be produced in large numbers. As a result, costs can be kept low and the line coding can be subsequently provided in a simple manner as required. In addition, the additional part being coded means all possible contact variants from different manufacturers can be used.

In one advantageous embodiment of the invention, the coding device comprises at least one coding groove, and the coding element is in the form of a coding ring with at least one coding rib. The dimensions of the coding groove and of the coding ring are such that only the line contact which is coded with the relevant coding ring can be correctly inserted into the pole chamber which is coded with the respective coding groove.

In this case, provision may be made for the coding ring which is arranged on the line contact to be able to rotate in a hollow-cylindrical holding region in the housing, so that it does not need to be freely rotatable on the associated line contact. In order to hold the coding ring, the hollow-cylindrical holding region for the coding ring may be arranged, for example, in the additional housing and face the basic housing. In contrast to an integral housing, the two-part form of the housing in this embodiment of the coding device has the advantage that the holding region can be formed in a manner which is simple in terms of the tools required.

In an alternative embodiment, the coding element is connected to the line contact as a separate component such that it can rotate in relation to the latter.

The coding element may be in the form of an injection-molded plastic part, for example.

In one advantageous embodiment, a plurality of coding ribs are arranged on the coding ring with mirror-image symmetry to a mirror axis which passes through the center of the ring, and a plurality of coding grooves are arranged in the additional housing with mirror-image symmetry to a mirror axis which passes through the middle of the pole chamber. This has the advantage that the coding ring cannot be incorrectly fitted, that is to say the coding ring always fits into the desired pole chamber.

In order to improve line guidance, particularly with an angled outgoing line connection, locking elements may be arranged on the additional housing for the purpose of locking the lines.

At least one of the lines is preferably in the form of an antenna line, for example an RF line, or an electrical power supply line or a control line. A combination of two or more of these types of lines on the line interface is possible too.

One advantageous embodiment of the invention is described below and illustrated in the drawings, in which:

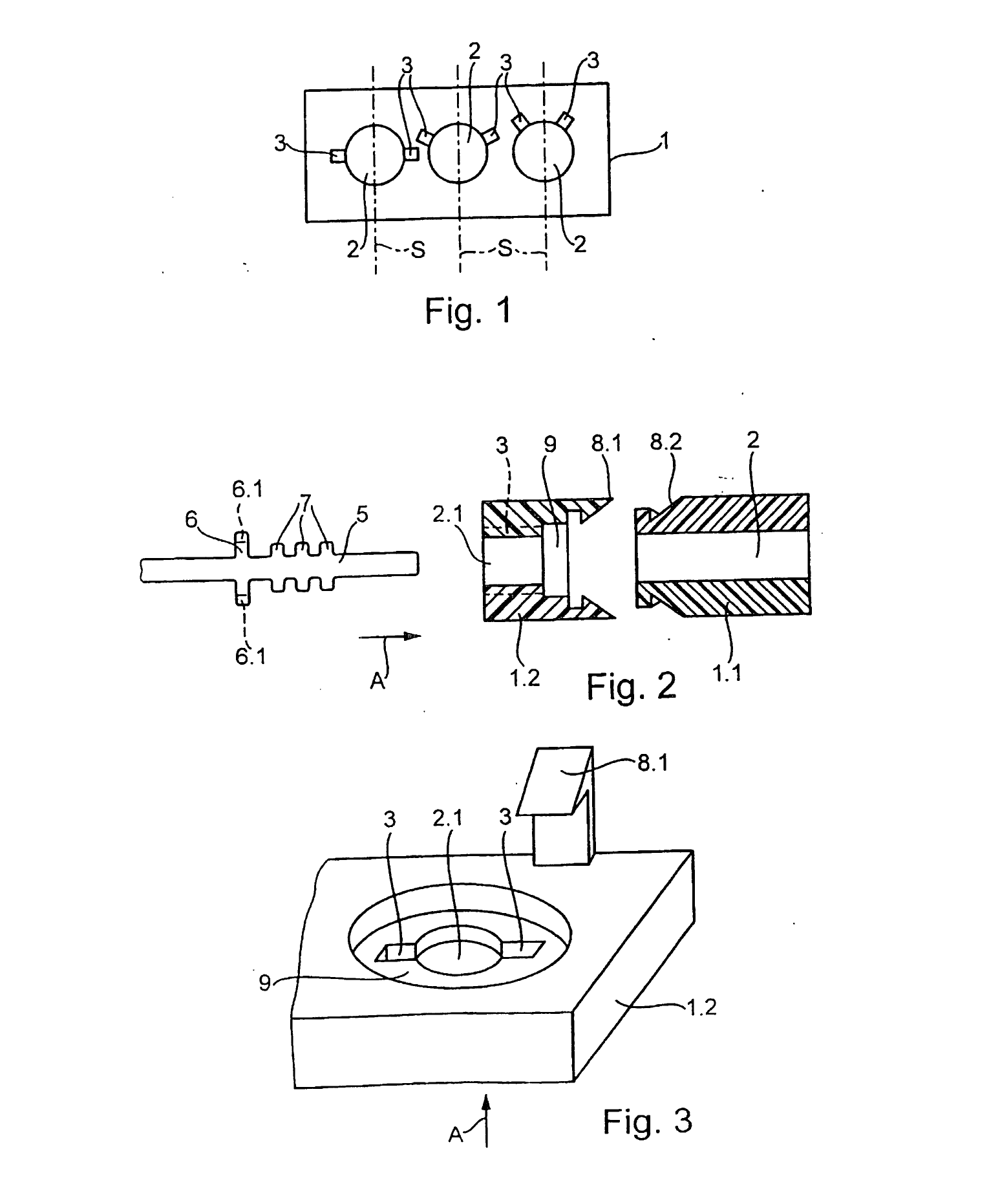

FIG. 1 shows a schematic plan view of a 3-pole plug housing;

FIG. 2 shows a section illustration through the individual components of the plug housing comprising a basic housing and an additional housing, and a line, which can be inserted, in a state in which it is not yet installed;

FIG. 3 shows a perspective partial view of the additional housing from FIG. 2;

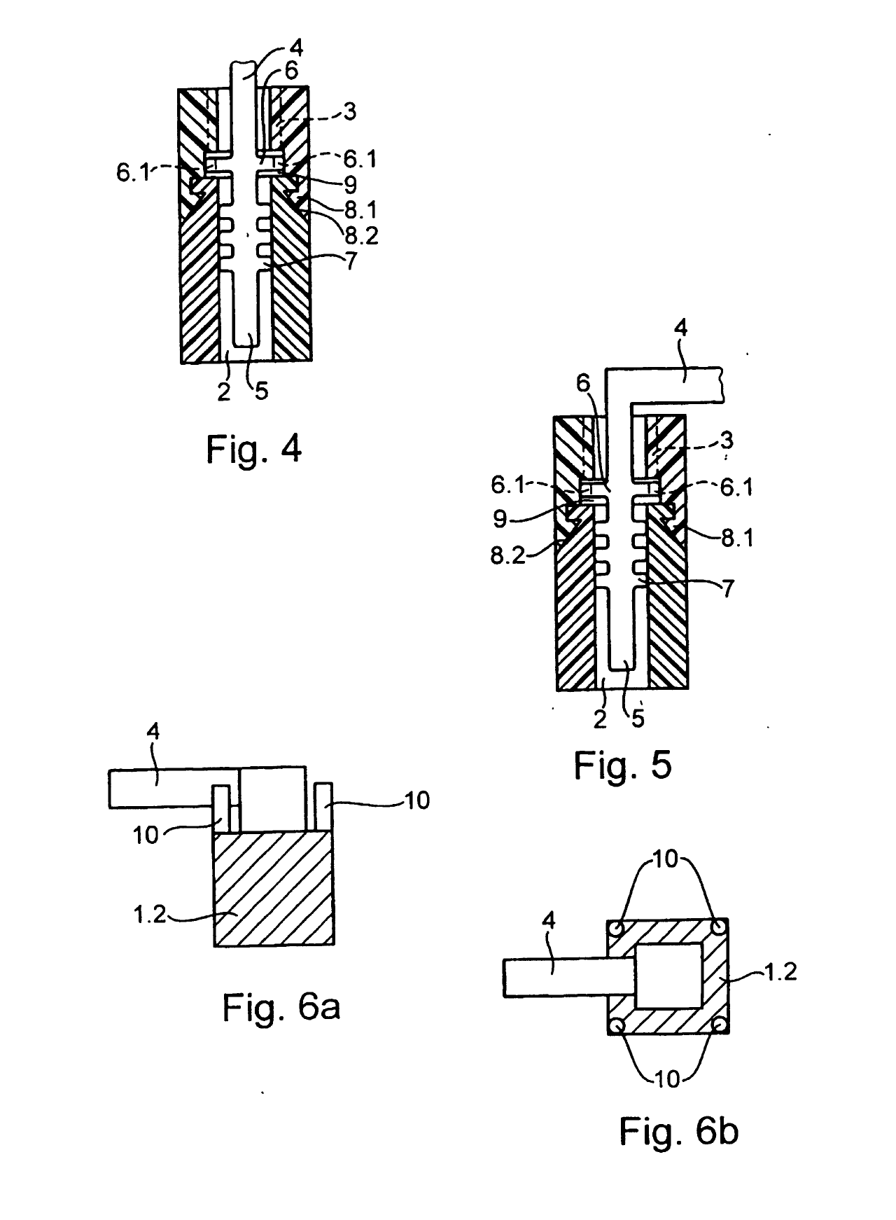

FIG. 4 shows a section illustration through the assembled components from FIG. 2;

FIG. 5 shows a section illustration through the assembled components which corresponds to FIG. 4, but for a variant with an angled outgoing line connection instead of a straight outgoing line connection,

FIG. 6a shows a side view of the additional housing for the variant from FIG. 5 with an angled outgoing line connection; and

FIG. 6b shows a plan view of the additional housing from FIG. 6a.

FIG. 1 shows a plan view of a plug housing 1 of a multipole line interface, in this case specifically a three-pole line interface. As can be seen in FIG. 1, a coding device with two coding grooves 3 in each case is provided in the plug housing 1 for each of three pole chambers 2.

A line 4 can be inserted into each pole chamber 2 for the purpose of mechanical connection to the plug housing 1. FIG. 2 shows, by way of example, a section illustration through a line 4 and the components of the plug housing 1 with an associated pole chamber 2, in the as yet uninstalled state. As can be seen in FIG. 2, the line 4 comprises a line contact 5 on which a coding element 6 is integrally formed, this coding element being in the form of a coding ring 6 with two coding ribs 6.1.

The line contact 5 may be, for example, an RF contact (radiofrequency contact) in which the coding element 6 is integrally formed with the metal line contact 5. Guide elements 7 are likewise integrally formed on the line contact 5 in order to axially guide the line contact 5 in the pole chamber 2 in an interlocking manner. The coding element 6 and/or the guide elements 7 may alternatively be in the form of separate components, for example injection-molded plastic parts, which are connected to the line contact 5 in a captive fashion, for example by being clipped into an annular groove in the line contact 5, particularly when transmitting other signals, for example DC voltage signals. It is also possible to form the coding element 6 with the guide elements 7 as a common separate component and fit the latter to the line contact 5 in a captive fashion.

As can also be seen in FIG. 2, the plug housing 1 comprises a basic housing 1.1 in which the pole chambers 2 are formed, and an additional housing 1.2 on which the at least one coding device 3 is formed. In the illustrated exemplary embodiment, the basic housing 1.1 and the additional housing 1.2 are in the form of separate components. However, as an alternative, it is also possible to form the basic housing 1.1 and the additional housing integrally. For connection purposes, the additional housing 1.2 comprises connecting elements 8.1 which form a releasable connection, for example a latching or clip connection, with corresponding connecting elements 8.2 on the basic housing 1.1.

In addition, the additional housing 1.2 comprises a hollow-cylindrical holding region 9 for the coding ring 6, this holding region facing the basic housing 1.1. When the line 4 is inserted into the plug housing 1, the coding ring 6 is axially passed through an aperture 2.1 in the additional housing 1.2 until it reaches the holding region 9, with the coding ring 6 being designed such that it can be inserted without becoming stuck and the coding ribs 6.1 fit into the coding grooves 3. The dimensions of the coding grooves 3 and the coding ribs 6.1 and/or the arrangement of the coding grooves 3 in the additional housing 1.2 and of the coding ribs 6.1 on the coding ring 6 are chosen such that only one line contact 5 which corresponds to a particular pole chamber 2 can be inserted into this pole chamber 2, with the relevant coding ribs 6.1 fitting only into the coding grooves 3 which belong to this pole chamber 2.

In the illustrated exemplary embodiment, the dimensions of the coding ribs 6.1 and the coding grooves 3 are matched to one another such that the coding ribs 6.1 can be axially inserted into the matching coding grooves 3. In addition, the coding grooves 3 are arranged in the additional housing 1.2 with mirror-image symmetry at different angles to a mirror axis S which passes through the middle of the pole chamber, as can be seen in FIG. 1, and, in a corresponding manner, the coding ribs 6.1 are arranged at a corresponding angular distance on the coding ring 6 with mirror-image symmetry to a mirror axis which passes through the center of the ring. As already mentioned, the advantage of this symmetrical arrangement of the coding components is that the coding ring 6 with the coding ribs 6.1, if it is in the form of a separate component, can be fitted on the line contact in both possible axial directions of the ring which are tilted through 180°, so that the orientation of the ring does not have to be considered when fitting the ring. Other arrangements and designs of the coding components are of course possible. The only important feature is that the dimensions and the arrangement and number of coding components on the line contact 5, on the one hand, and in the additional housing 1.2, on the other, are matched to one another such that only a line contact 5 which belongs to a particular pole chamber 2 can be inserted into this pole chamber 2.

The holding region 9 means the line contact 5 can be rotated in the pole chamber 2 as required, even when the coding element 6 is integrally formed. Arrow A from FIGS. 2 and 3 indicates the direction in which the line contact 5 is inserted into the plug housing 1. FIG. 3 shows a detail of a view of that part of the additional housing 1.2 which faces the basic housing 1.1. As mentioned above in relation to FIG. 2, the coding ring 6, which has the coding ribs 6.1, of the line contact 5 can be axially inserted through the aperture 2.1 and the coding grooves 3 until the coding ribs 6.1 of the coding ring 6 are in the holding region 9.

FIGS. 4 and 5 each show the fully assembled state of the additional housing 1.2, which is connected to the basic housing 1.1 by means of the connecting elements 8.1 and 8.2, with line contacts 5 inserted. The guide elements 7 of the line contact 5 bear against the walls of the pole chamber 2 for the purpose of axially guiding the line contact 5. The coding ring 6 with the coding ribs 6.1 is inserted into the holding region 9. FIG. 4 shows a line contact 5 with a straight outgoing connection of the line 4, and FIG. 5 shows a line contact 5 with an angled outgoing connection of the line 4.

FIGS. 6a and 6b respectively show a side view and a plan view of the additional housing 1.2 with the angled outgoing connection of the line 4 in accordance with FIG. 5. As can be seen in these figures, the line 4 is guided and flanked by locking means 10, for example by locking pins or arcuate bulges or the like. FIG. 6a shows a side view and FIG. 6b shows a plan view of the additional housing.

In the described exemplary embodiment, the line contact 5 and the coding element 6 with the coding ribs 6.1 are integrally formed. As mentioned, the coding element may of course also be in the form of a separate component and be connected to the line contact 5 in a captive fashion such that it can rotate. The advantage of the ability to rotate is that the line contact 5 can be easily inserted into the plug housing 1 yet remain able to rotate with respect to the latter. In this case, the holding region 9 is not absolutely necessary because the coding element does not impede the ability of the line 4 to rotate in the housing 1.

Although the invention has been described in detail above with reference to plugs for electrical motor-vehicle components, it goes without saying that multipole line interfaces according to the invention are also suitable for all other applications in which it is necessary to mechanically connect a plurality of lines to a housing by means of line contacts at their ends, in order to create an electrical connector, by inserting the line contacts into a respective pole chamber. The invention prevents, in a simple manner, an incorrect line from being inserted into a pole chamber and prevents lines from being mixed up when being inserted into the pole chambers.

1. A multipole line interface having a housing (1) and at least two lines (4) which can be connected to the housing (1) by inserting a line contact (5) of the respective line (4) into a respective pole chamber (2), characterized in that
the housing (1) comprises a coding device (3) for at least one of the pole chambers (2), with the coding device being designed specifically to hold a coding element (6) which is connected to the associated line contact (5) in a captive fashion.

2. The multipole line interface as claimed in claim 1, characterized in that the housing (1) comprises a basic housing (1.1) in which the pole chambers are formed, and an additional housing (1.2) in which the at least one coding device (3) is formed.

3. The multipole line interface as claimed in claim 1, characterized in that the coding element (6) is connected to the line contact (5) as a separate component such that it can rotate.

4. The multipole line interface as claimed in claim 1, characterized in that the coding element (6) is integrally formed with the line contact (5).

5. The multipole line interface as claimed in claim 1, characterized in that the coding element (6) is in the form of an injection-molded plastic part.

6. The multipole line interface as claimed in claim 1, characterized in that the coding device (3) comprises at least one coding groove (3), and the coding element (6) comprises a coding ring (6) with at least one coding rib (6.1).

7. The multipole line interface as claimed in claim 6, characterized in that the additional housing (1.2) has a hollow-cylindrical holding region (9) for the coding ring (6), this hollow-cylindrical holding region facing the basic housing (1.1).

8. The multipole line interface as claimed in claim 6, characterized in that a plurality of coding ribs (6.1) are arranged on the coding ring (6) with mirror-image symmetry to a mirror axis which passes through the center of the ring.

9. The multipole line interface as claimed in claim 8, characterized in that a plurality of coding grooves (3) are arranged in the additional housing (1.2) with mirror-image symmetry to a mirror axis (S) which passes through the middle of the pole chamber.

10. The multipole line interface as claimed in claim 1, characterized in that the additional housing (1.2) is releasably connected to the basic housing (1.2), particularly by means of clips.

11. The multipole line interface as claimed in claim 1, characterized in that the additional housing (1.2) and the basic housing (1.1) are integrally formed.

12. The multipole line interface as claimed in claim 1, characterized in that the housing (1), particularly the additional housing (1.2), has locking elements (10) for the purpose of locking the lines (4).
